(19) United States
(12) Patent Application Publication
(10) Pub. No.: US 2020/0183745 A1
(43) Pub. Date: Jun. 11, 2020

(54) METHOD, DEVICE AND COMPUTER PROGRAM FOR DYNAMICALLY ALLOCATING RESOURCES IN A MULTI-PROCESSOR COMPUTER SYSTEM

(71) Applicant: TTZ EMBEDDED SYSTEMS INNOVATIONSGESELLSCHAFT TECHNISCHE UNIVERSITÄT BRAUNSCHWEIG MBH, Braunschweig (DE)

(72) Inventors: Rolf ERNST, Braunschweig (DE); Adam KOSTRZEWA, Braunschweig (DE); Sebastian TOBUSCHAT, Braunschweig (DE)

(21) Appl. No.: 16/638,098

(22) PCT Filed: Aug. 10, 2018
(86) PCT No.: PCT/EP2018/071780

§ 371 Date: Feb. 10, 2020

(30) Foreign Application Priority Data
Aug. 11, 2017 (DE) 10 2017 214 068.2

(51) Int. Cl. G06F 9/50

(52) U.S. Cl. CPC G06F 9/505; G06F 2209/501

(57) ABSTRACT

Suggested are methods and devices for dynamic resource allocation in a multiprocessor computer system with a plurality of components. The method comprises different steps, such as receiving a request for access to a shared resource, wherein after the allocation of the requested shared resource to the requesting unit, a prescribed real-time requirement is to be ensured by the multiprocessor computer system. Based on the operating parameters determined for a design time of the multiprocessor computer system and current operating parameters, future operating parameters to be expected after an allocation of the requested shared resource are determined. If the prescribed real-time requirement operating parameters is to be ensured in the future, the requested resource is allocated to the requesting unit.

### BACKGROUND OF THE INVENTION

### Field of the Invention

The present invention relates to a method for dynamic allocation of resources in a multiprocessor computer system comprising a plurality of components, as well as a corresponding device and a corresponding computer program.

### Description of the Prior Art

Multiprocessor computer systems, that are, for example, available in the form of integrated circuits, comprise two or more processors that are able to perform different processes independently. The several processors share existing hardware and software resources of the multiprocessor computer system. These hardware and software resources include memories such as main memory and cache memory, communication means such as data bus or network, input and output means as well as, if necessary, further components of the multiprocessor computer system.

While the shared use of hardware and software resources can bear advantages with regard to an efficient use of these resources due to the several processors, this shared use can, however, also involve disadvantages in some applications. For example, the mentioned real-time systems have to meet high requirements with regard to response and execution times.

Response and execution times in systems with jointly used hardware and software resources are mainly determined by accesses to these jointly used hardware and software resources. If resources that are accessed often are need, this can lead to longer response and execution times. Some resources, such as the cache memory, can also show a strongly dynamic behavior. In addition, the shared use of hardware and software resources, in particular due to components such as the processors operating in an independent manner, can involve access conflicts. In sum, a guarantee of the required real-time requirements is therefore hardly possible.

A so-called Network on Chip, NoC for short, is a special form of a communication means in a multiprocessor computer system. An NoC is a communications architecture comprising at least one router, wherein each hardware resource of the multiprocessor computer system has a unique address. The individual resources comprise network interfaces that enable a connection with one or more routers of the NoC. Further, the NoC comprises direct data lines between resources and routers. A communication between the resources is based on the transmission of data packets that are routed from a start resource to one or more target resources by means of the data lines across one or more routers. In particular, NoCs are suitable for use in the above-mentioned real-time systems.

One possibility to be able to fulfill high real-time requirements lies in strongly oversizing multiprocessor computer systems in order to ensure that even in a worst case scenario, there are always enough free hardware and software resources available in the system. This, however, leads to a great amount of hardware and software resources, which is also applied in all other scenarios except the worst case scenario, because otherwise, it cannot be guaranteed that the software programs can be executed with a guaranteed response behavior. In other words, if it is possible to reserve all required resources in a manner that prevents all influencing, an overestimation of the runtime would not be necessary. Thus, currently used multiprocessor computer systems result in a suboptimal utilization of the available resources, if the response behavior of the applications shall be exactly predictable.

In sum, currently used multiprocessor computer systems are highly complex with regard to the management of their resources such as memories, communication means or input and output channels or the compliance with real-time requirements, in order to be able to carry out security-critical applications, for example. The German patent specification DE 10 2009 016 742 B4 already suggested the use of a central resource manager (RM) that coordinates the allocation of resources. The RM, which is preferably located on the same chip as the processors, receives reservation requests and checks, based on a system model, whether a reservation request can be fulfilled at all. If a reservation request is accepted, the RM chooses the required resources, allocates them and thus guarantees a specified time of execution.

Particularly in connection with a multiprocessor electronic control unit (ECU), as it is used, for example, in a vehicle, is the resource management especially complex. Predictable behavior is necessary for security-critical processes. This means that the computer system has to ensure that, independent of the current load or external circumstances, the request is carried out within the requested time by means of applications carried out by the computer system. For this purpose, usually formal guarantees regarding the design time that assume a worst case scenario, are determined. With regard to the runtime, the system will ensure, by means of the suggested RM for example, that the formal guarantees are complied with by ensuring that there are always sufficient resources for a possibly occurring security-critical function available. This means that multiprocessor computer systems that have to perform security-critical processes, always have to take the worst case as a basis.

There is a need for improvement of the existing approaches for resource allocation in a multiprocessor computer system such as, for example, an integrated circuit, without jeopardizing the formal guarantees.

### SUMMARY OF THE INVENTION

The invention is defined by the independent claims. Further advantageous embodiments are specified in dependent claims.

In order to achieve the object mentioned above, the present invention provides a method for dynamic resource allocation in a multiprocessor computer system comprising a plurality of components. The plurality of components comprises two or more processors, a resource management component and a communication means for a communication between the processors and one or more shared resources.

The method comprises a reception by the resource management component and a request for access to one of the shared resources from a requesting unit. After an allocation of the requested shared resource to the requesting unit, at least one prescribed real-time requirement is to be ensured by the multiprocessor computer system. Further, the method comprises a determination of one or more current operating parameters of the multiprocessor computer system by means of the resource management component, as well as a determination of one or more future operating parameters to be expected after an allocation of the requested shared resource to the requesting unit, based on a model of the multiprocessor computer system created for the design time of the multiprocessor computer system and one or more determined current operating parameters by the resource management component.

According to the method, the requested shared resource is allocated to the requesting unit by the resource management component, if the prescribed real-time requirement based on the determination of future operating parameters to be expected can be ensured.

In order to achieve the object mentioned above, the present invention further provides a corresponding device comprising means for carrying out the method as well as a corresponding computer program. The computer program may be stored on a non-transitory storage medium.

Further, the present invention provides a method for dynamic resource allocation in a multiprocessor computer system comprising a plurality of components, wherein said plurality of components comprises one or more processors, a resource management component and a communication means for a communication between the processors and the one or more shared resources.

The method comprised a determination of a real-time requirement that is to be ensured by the multiprocessor computer system after a reconfiguration of the multiprocessor computer system by the resource management component. Further, the method comprises a determination of one or more current operating parameters of the multiprocessor computer system by means of the resource management component, as well as a determination of one or more future operating parameters to be expected after a reconfiguration, based on a model of the multiprocessor computer system created for the design time of the multiprocessor computer system and one or more current determined operating parameters by the resource management component.

If the real-time requirement based on the determination of the future operating parameters to be expected is ensured, a reconfiguration is carried out by the resource management component of the multiprocessor computer system.

In deviation from the prior art, the resource management component according to the invention thus is no longer only based on a worst-case scenario determined for the design time regarding the load of the multiprocessor computer system. Instead, one or more current operating parameters of the multiprocessor computer system are determined and the available resources are adjusted to these parameters. Thus, resource requests according to the invention can also be granted if there is already a high utilization, which, in the prior art, would have led to a rejection of the request, for example if the determined parameters indicate advantageous conditions for the requested resource(s). Thus, the invention uses the resources in more efficient manner than was possible according to the prior art. In particular, it is in accordance with the invention that an adaption of reserved resources that were generously dimensioned with regard to real-time requirements for the design time, is carried out, because such a generous reservation is only necessary for the worst case described above and thus is an inefficient use of resources in most applications.

Both the above general description and the detailed description are to be understood as examples and are to serve as explanations for the claimed invention. Further advantages and features of the invention can be gathered from the below description, the drawings and the patent claims.

### BRIEF DESCRIPTION OF THE DRAWINGS

The features characterizing the invention are explained in more detail in the enclosed claims. The invention itself, however, is best explained by the below detailed description, which describes an exemplary embodiment of the invention with reference to the drawings:

FIG. 1 is a schematic representation of a device according to some embodiments of the present invention.

FIG. 2 is a flowchart showing the steps of a method according to some embodiments of the present invention.

FIG. 3 is a flowchart showing the steps of a method according to some embodiments of the present invention.

### DETAILED DESCRIPTION OF THE INVENTION

The enclosed drawings, the technical content and the detailed description refer to the preferred embodiments of the invention, which, however, is not to be understood as a limitation of the subject matter of the invention. All equal variations and changes that are made according to the enclosed claims of the present invention, are covered by these claims.

Below, the invention is explained in more detail based on the drawings.

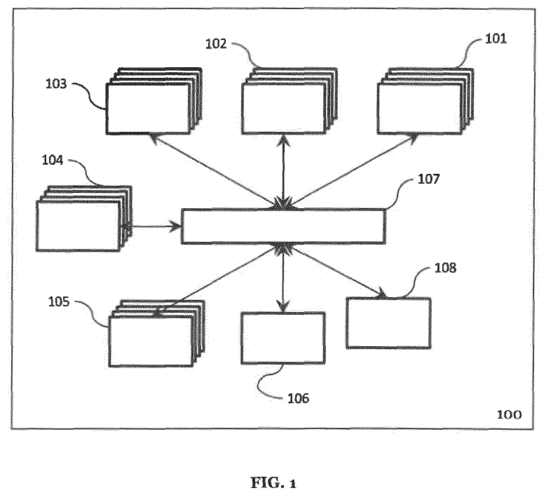

FIG. 1 is a schematic representation of a device too according to some embodiments of the present invention. The device shown in FIG. 1 is, for example, configured as a multiprocessor computer system and comprises two or more processors 103. Further, the device too comprises several resources that are shared between the processors, such as, for example, jointly used memories (shared memory) 102, in particular main memories or cache memories, sensors or actuators 101, a main memory controller 104, a hardware accelerator 105 and a gateway 108. The gateway 108 serves as an interface to an external communications module that enables the data communication with external components. The components of the multiprocessor computer system 100 mentioned above can also be present several times. The shared resources 102 can be configured as internal resources or as resources 102 that are external with regard to the multiprocessor computer system 100.

Further, the multiprocessor computer system 100 shown in FIG. 1 comprises a resource management component (resource manager for short) 106. The components of the multiprocessor computer system 100, meaning the processors and the shared resources in particular, are coupled via a communication means 107, by means of which data can be exchanged with each other. The communication means 107 is also a shared resource.

Examples for components of the multiprocessor computer system 100 include clients, monitors, network interfaces, DMC (interface/engine), ethernet (interface), gateway or SDN controllers.

In this regard, clients, monitors or network interfaces play a special role. These components are components that are arranged between a processor 103 (or another component) and a communication means 107. These components are capable of recognizing an access. For example, such a component allocated to a processor recognizes if an application of the processor allocated to it accesses a shared resource (or the communication means) and in response, sends a corresponding request to the resource management component 106. In case of a client or a network interface, the desired access can be trapped until the resource management component 106 grants access. This enables a transparent implementation of the method according to the invention without the concerned component intending to access the shared resource having to send a request itself. In such case, the request is made by the requested shared resource.

The sensors and actuators 101 comprise different kinds of sensors, for example:
a) Sensors for the detection of states within the system, such as temperature or load;
b) Sensors for the detection of external events, such as distance sensors for driver assistance systems;
c) Sensors for the detection of external events that can be used for a feedback, such as, for example, cameras for driver assistance systems. Depending on the surroundings, a corresponding camera delivers different amounts of data, which can be used, for example, as input for the reconfiguration of the system.

In some embodiments, the communication means (107) is configured as a communication means for an internal communication between components of the multiprocessor computer system (100) and/or components external to the multiprocessor computer system.

In particular, the communication means 107 is configured as an NoC in some embodiments. This is particularly advantageous if the multiprocessor computer system 100 is an integrated circuit and in particular a multiprocessor electronic control unit (ECU) within a vehicle, which has to meet considerable real-time requirements.

In some embodiments, in which the multiprocessor computer system 100 is configured as an integrated circuit, this integrated circuit can in turn comprise several integrated circuits. Further, one or more integrated circuits can be configured as a system on package (SoP).

Due to its special architecture, an NoC, being a communication means within the circuit, is able to contribute to ensuring these considerable real-time requirements under all operating conditions and system states.

In some embodiments, the communication means 107 is configured as a communication means for a communication between integrated circuits of the multiprocessor computer system 100, meaning as communication means between different circuits in a package. In such embodiments, each processor 103 is configured as an individual die, wherein the processors within the package are connected via a NoC.

The device shown in FIG. 1 can, for example, be configured as a system in package (SiP; several circuits or dies within one package or chip, including vertical integration), as a multichip module (MCM, several circuits or dies in one package/chip/housing, arranged in a planar manner to one another) or as a system on chip (Soc, several components in a single die or circuit). An SiP or MCM can also comprise several SoCs as well as corresponding shared resources and communication means.

A further advantage of a NoC as internal communication means lies in that an optimized communication is enabled, even if the multiprocessor computer system is configured as an integrated circuit and in particular constitutes a heterogeneous network. Heterogeneous networks are characterized in that one or more clock frequencies can be used for the components of the integrated circuit and/or different router architectures and/or correspondingly different protocols that can be implemented on the same integrated circuit.

In addition, or in the alternative, heterogeneous networks with different bandwidths are possible on the connections between routers of the NoC and components of the integrated circuit 100, which communicate by means of the NoC router.

The multiprocessor computer system 100 according to the invention enables such heterogeneous network architectures to also meet specified real-time requirements.

In some embodiments, the multiprocessor computer system 100 comprises several resource management components 106 that can be configured differently with regard to their complexity and/or functionality. Each resource management component 106 can be implemented in the form of hardware and/or software.

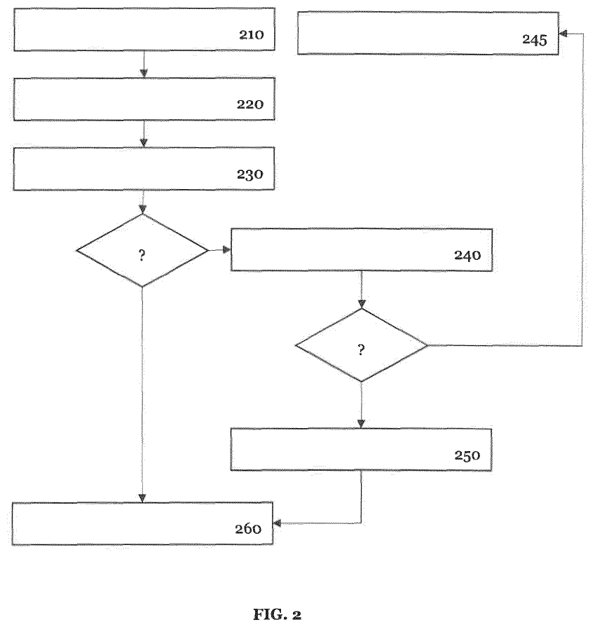

FIG. 2 is a flowchart showing the steps of a method according to some embodiments of the present invention.

In a first step 210 of the method, the resource management component 106 receives a request for access to one of the shared resources 102-108 from a requesting unit. The requesting unit is, for example, an application that is carried out on one or more of the processors 103 or another component of the multiprocessor computer system 100. However, the requesting unit can also be a component external from the system. The shared resource, to which the request is directed, can, for example, be a sensor lot, an actuator 101, a memory 102, in particular main memory or cache memory, a memory controller 104, a hardware accelerator 105, the communication means 107 or an input/output means. In general, the requested resource can be any hardware or software resource of the multiprocessor computer system 100. If the requested resource is the communication means 107, the request can also be directed to parts of the communication means 107, for example a connection, paths, routers, (virtual) channels or buffers.

After an allocation of the requested shared resource 102 to the requesting unit, at least one real-time requirement is to be ensured by the multiprocessor computer system 100. In some embodiments, the request comprises at least one parameter. For example, the parameter comprises a type, a scope and/or a time response of the requested shared resource 102. Further examples include a minimum data throughput on the communication means 107 (for example a number of incoming data packets per time unit) or a maximum allowed response time (e.g. a maximum allowed transmission latency).

In a further step 220, the resource management component 106 determines one or more current operating parameters of the multiprocessor computer system 100. For this purpose, the resource management component 106 can use the sensors 101 in particular. The sensors 101 can recognize a plurality of operating parameters, such as, for example, a behavior of the requesting unit, including a state and/or a pattern of previous resource accesses of the requesting unit, an electric voltage and/or a clock frequency by means of which one or more of the components of the multiprocessor computer system are operated, a temperature of one or more components of the multiprocessor computer system or a number of data packets that were transmitted within a specified time period via the communication means 107. For example, the number of data packets can be an average number or a maximum number that is transmitted during a specified period of time via the communication means 107.

In step 230, the resource management component 106 determines one or more future operating parameters to be expected after an allocation of the requested shared resource 102 to the requesting unit. In this regard, this determination can be based on one or more factors. In particular, the estimate can be based on a model of the multiprocessor computer system created for the design time of the multiprocessor computer system 100, as well as on the one or more determined current operating parameters. It is further possible that the determination is only based on one of these two factors.

In this regard, the determination of the one or more future operating parameters to be expected comprises, for example, a determination of an electric voltage and/or clock frequency to be expected after a requested shared resource 102 was allocated to the requesting unit, by means of which said one or more of the components of the multiprocessor computer system 100 are operated. Further, a future temperature of one or more components of the multiprocessor computer system 100 that is to be expected, can also be determined. A further variation is the determination of an average number of transmitted data packets that are to be expected via the communication means within a specified period of time.

The execution of the next steps of the method depends on a result of a distinction between cases.

An allocation 260 of the requested shared resource to the requesting unit by the resource management component is carried out, if the prescribed real-time requirement based on the determination 230 of future operating parameters to be expected, can be ensured.

If, however, the prescribed real-time requirement, based on the determination 230 of the future operating parameters to be expected is not ensured, a determination 240 of a configuration of one or more components of the multiprocessor computer system 100 is carried out on the basis of one or more determined current operating parameters and the one or more future operating parameters to be expected in that the prescribed real-time requirement is ensured for the requested resource 102 due to the configuration.

In other words, the resource management component 106 checks whether the prescribed real-time requirement can be fulfilled, if the requested resource is allocated to the requesting unit under the currently given operating conditions of the multiprocessor computer system 100. This determination is not only based on a model of the multiprocessor computer system, previously created during the design time of the multiprocessor computer system 100, meaning, for example, the specification of a multiprocessor computer system configured as an integrated circuit, which exist in security-critical systems for the applications and the platforms in order to determine the limits for the allowed behavior of the system and all interfering applications, but, in addition, on operating parameters currently observed during the runtime.

Thus, the resource management component 106 uses this information determined for the design time and simultaneously, information regarding he current state of the multiprocessor computer system 100 during the runtime. This kind of link between information regarding design time and information regarding runtime allows for the adaption of the configuration of the multiprocessor computer system 100 in a manner dynamic to the runtime. In other words: The information regarding design time is combined with feedback regarding the runtime before a decision regarding the rejection of a request is made. By means of these models and limits of the system created and determined for the design time it can be guaranteed that the resource management component 106 only determines and uses valid configurations, meaning such configurations in which the necessary real-time requirement to which the multiprocessor computer system 100 is made subject, can be met. In this manner it is further possible to realize further optimization goals, such as, for example, a guaranteed minimum data throughput at a simultaneously low thermal load of the multiprocessor computer system and its components.

It can happen, although considerably less often that in the prior art, that no corresponding configuration can be determined. In such a case, the resource management component 106 sends a rejection message to the requesting unit in step 245 and thus rejects the request for the shared resource.

Otherwise, meaning if a corresponding configuration could be determined for which the prescribed real-time requirement is probably ensured, one or more components of the multiprocessor computer system 100 are configured in step 250 according to the configuration determined in step 240.

The configuration 250 of one or more components of the multiprocessor computer system 100 can be carried out in many ways. For example, a clock rate and/or a frequency can be adjusted, by means of which said one or more of the components of the multiprocessor computer system 100 are operated. An adjustment of a maximum amount of data to be transmitted and/or received per time interval for an application carried out on one or more of the processors 103 or for a component of the multiprocessor computer system 100 is also possible. It is further possible to reroute data packets existing or to be transmitted in the communication means 107. Further, the applications performed on one or more of processors 103 can be deactivated or activated, or individual components of the multiprocessor computer system 100 can be activated or deactivated. In addition or as an alternative it is possible to adjust a response behavior of an application carried out on one or more of processors 103.

After the configuration 250, the requested resource 102 is then allocated to the requesting unit in step 260. The allocation 260 of the requested resource to the requesting unit can be carried out, for example, by establishing a communication connection between the requesting unit and the requested resource 102 via the communication means 107.

In some embodiments, the allocating 260 of said requested resource 102 to the requesting unit comprises a confirmation of the request prior to the allocation.

In some embodiments, the resource management component 106 is able to check the requesting unit or both alternative configurations, if the desired communication connection to the shared resource 102 cannot be established. If such an alternative configuration that is suitable for fulfilling the real-time requirement is found, the concerned alternative configuration is realized by the resource management component 106.

Some embodiments are characterized in that the resource management component 106 receiving the request or another resource management component receiving a request from a resource management component, evaluates the request with regard to validity, enablement, performance, security and/or influence on other components of the multiprocessor computer system 100 and rejects the request in case of a negative evaluation or changes the parameters and repeats the evaluation.

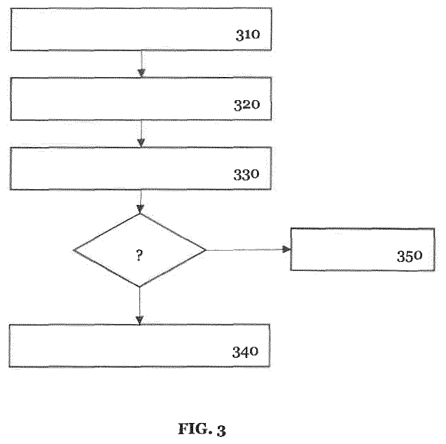

FIG. 3 is a flowchart showing the steps of a method according to some embodiments of the present invention.

According to these further embodiments it is provided that the resource management component only adjusts the configuration of parts of the configuration based on the current state of the system or used resources (internally also as periphery) or on the applications running on the processors. With this it is enabled that the resource management component uses information regarding the state of the system, which, for example, is derived from information from monitoring devices or from the behavior of periphery components, to adjust the configuration even without an existing request or connection request of a requesting unit for optimizing or complying with the guarantees and real-time requirements (proactive behavior).

In these embodiments, the examination of the system and the potential reconfiguration is not triggered by a request for an access to a shared resource. Instead, the examination and reconfiguration is, for example, controlled by an event, meaning in reaction to a recognized event. A further possibility lies in that the examination and reconfiguration happens periodically in specified time intervals, for example.

Such a triggering event is, for example, the exceeding of a boundary value. The periodic examination is carried out, for example, by reading a sensor in specified time intervals.

Examples for possible triggers for the examination and reconfiguration are:
Exceeding a temperature of the multiprocessor computer system or of one of its components (as a possible response, a frequency, by means of which the system or a component is operated, is slowed down, or rate limiters at the network interface are slowed down, for example)
Understepping a temperature (as a possible response, a frequency is increased, for example)
Response time and/or data throughput of the NoC insufficient/too much data traffic (as a possible response, the frequency is increased, functions or components are slowed down or switched off or data packets are rerouted, for example)

In these embodiments, in which a request for a resource is not the triggering event, the compliance with specified guarantees and operating parameters as well as a corresponding automatic adjustment of operating parameters are monitored in general, in order to comply with these guarantees and, if necessary, to achieve further optimization goals (for example, minimum power consumption at simultaneous compliance with the real-time requirement).

It is to be noted that these guarantees and/or optimization goals are known and specified beforehand, because they were, for example, created and specified for the design time of the multiprocessor computer system. The resource management component has access to these previously specified guarantees and/or optimization goals.

In some embodiments, the guarantees and/or optimization goals can be changed subsequently (for example by means of updates) and/or at the runtime (for example by means of a resource management component learning through “machine learning”).

In particular, the method according to this further embodiment comprises a determination 310 of a real-time requirement that is to be ensured by the multiprocessor computer system after a reconfiguration of the multiprocessor computer system, by the resource management component, as well as a determination 320 of one or more current operating parameters of the multiprocessor computer system by the resource management component. The method further comprises a determination 330 of one or more future operating parameters to be expected after said reconfiguration, based on a model of the multiprocessor computer system created for the design time of the multiprocessor computer system and one or more determined current operating parameters by the resource management component. If the real-time requirement based on the determination 330 of the future operating parameters to be expected is ensured, a reconfiguration 340 is carried out by the resource management component of the multiprocessor computer system.

If the real-time requirement based on the determining 330 of the future operating parameters to be expected is ensured, the method ends in step 350, without a reconfiguration of the multiprocessor computer system being carried out.

In an example, the course of the method according to these further embodiments is triggered by a periodic reading of a sensor or a periodic check of the operating parameters or due to one or more occurring events, such as errors, mode changes or changes in the data volume. Here, the resource management component is the able to determine the real-time requirements to be ensured in step 310. The real-time requirements to be ensured can, for example, be determined at the design time or by a previous request. It may also have been changed due to a mode change, where it is both possible that the changed real-time requirement is a real-time requirement that is stricter when compared to the previous real-time requirement, or a less strict real-time requirement when compared to the previous real-time requirement.

In addition, the runtime information regarding the current operating parameters, such as temperature, existing data streams, used data paths, necessary data throughput, clock frequency/frequencies or voltage(s), is detected in step 320. Based on the real-time requirement, the model of the system created for the design time and the current operating parameters determined for the runtime, the resource management component is then able to determine a new possible configuration that complies with the real-time requirement and other requirements regarding the operating parameters (such as maximum temperature or maximum power consumption) and/or achieves optimization goals regarding the operating parameters, such as, for example, a minimum power consumption, an even aging of components, maintenance of the response behavior, maintenance of the function, etc. For this purpose, the resource management component usually determines in step 330, how the operating parameters behave under this new possible configuration, based on the model and the operating parameters determined for the runtime.

When a configuration enabling compliance with the potentially changed real-time requirement to be ensured, is found, it can be configured by the resource management component, for example in a step 340, with the configuration comprising, for example, one or more of:
(a) Slowing down traffic, for example by means of one or more rate limiters,
(b) reducing clock frequencies of one or more components,
(c) rerouting data packets, for example on alternative paths in a network
(d) changing the priorities of data streams.

In this regard, the configuration can concern both transmitters with real-time requirements as well as such without real-time requirements. This can be important in certain cases, as, for example, a slowed-down data stream can influence other data traffic in the network and thus the latter may also have to be adjusted.

A specific application for this course is the treatment of a too high temperature of a component. In this case, the resource management component detects, for example by reading a sensor or by a report from the sensor to the resource management component, that there is a too high temperature at a component, such as, for example, a network router. As a too high temperature can increase the probability of failure and the power consumption, the resource management component determines a new configuration for one or more components in this example. A possible new configuration, which lowers the temperature, is, for example, a reduced clock frequency of the network router in which the too high temperature was detected. In order to still ensure all real-time requirements, it may further be necessary to reroute network traffic in order to compensate for the reduced, possible throughput of the network now operating at a lower clock rate.

A further specific application for this course is the treatment of a utilization of a component that is lower than was assumed by the requests or the model created for the design time. In this regard, the resource management component detects, for example by reading a sensor or by a report from the sensor to the resource management component, that a transmitter transmits less data than previously assumed. As the current configuration assumes a higher data volume, there is space for an optimization of the system, for example with regard to power consumption. Therefore, this resource management component determines a new configuration for one or more components. A possible new configuration, which lowers power consumption, may, for example, be a reduced clock frequency of one or more components. In order to still ensure the real-time requirements, it may additionally be necessary to reroute or slow down the network traffic or to adjust the priorities of the data packets in order to compensate for the reduced performance of the components now operating at a slower clock rate.

A further specific application for this course is the treatment of a utilization of a component that is higher than was assumed by the requests or the model created for the design time. In this regard, the resource management component detects, for example by reading a sensor or by a report from the sensor to the resource management component, that a transmitter transmits more data than previously assumed. As the current configuration assumes a lower data volume, the guarantee of real-time requirements is threatened. Therefore, this resource management component determines a new configuration for one or more components. A possible new configuration that ensures the real-time requirements is, for example, an increased clock frequency of one or more components. If an increase of the clock frequency is not possible, because, for example, the maximum frequency or temperature was already reached, another different configuration lies in the slowing down or rerouting of data traffic in order to reduce interferences or the data volume at the component.

A further specific application for this course is the treatment of an error, such as the failure of a network router or of the connection between two network routers. Traffic via this faulty component can experience an exceeding latency, may be blocked permanently or be lost. Therefore, this resource management component determines a new configuration for one or more components. A possible new configuration is, for example, a rerouting of the data traffic via alternative paths in the network. Since therefore, an increased traffic volume may occur on these paths, it may be necessary to increase the clock frequency of network routers on the new paths, to slow down one or more transmitters of these paths or to switch off or further reroute transmitters on these paths.

In one application, the course of the method may also be used for treating a reduced real-time requirement. A transmitter may have different modes. One example would be a controller in a vehicle, which, depending on the vehicle's state (parking, driving forward, driving in a car park, driving on the highway, driving on a clear road, driving in a convoy), can pose different bandwidth requirements to the components. If the resource management component detects a reduced requirement of the transmitter (or another component), there can be space for optimizing the system, to the extent that the real-time requirement remains ensured, even in case of an optimized configuration, for example with regard to power consumption or the resources available to others. Therefore, this resource management component can determine a new configuration for one or more components. A possible new configuration, which lowers power consumption, may, for example, be a reduced clock frequency of one or more components. One possible new configuration, which increases the resources available to other transmitters, lies, for example, in increasing the allowed amount of data in rate limiters. In order to still ensure the real-time requirements, it may additionally be necessary to reroute or slow down the network traffic or to adjust the priorities of the data packets in order to compensate for the reduced performance of the components now operating at a slower clock rate or to oppose the now changed data volume.

In one application, the course of the method may also be used for treating an increased real-time requirement. A transmitter can, as was stated above, have different modes, for example a controller in a vehicle, which, as was stated above, depending on the vehicle's state (parking, driving forward, driving in a car park, driving on the highway, driving on a clear road, driving in a convoy), can pose different bandwidth requirements to the components. If the resource management component detects an increased requirement of a transmitter (or another component), the guarantee of real-time requirements with the current configuration can be threatened. Therefore, this resource management component can determine a new configuration for one or more components. A possible new configuration that ensures the real-time requirements is, for example, an increased clock frequency of one or more components. If an increase of the clock frequency is not possible, because, for example, the maximum frequency or temperature was already reached, another different configuration lies in the slowing down or rerouting of data traffic in order to reduce interferences or the data volume at the component.

For example, a treatment of a data stream across components of varying speeds is also enabled by the explained method. This can be the case, for example, in a Network on Chip comprising different voltage islands. In this regard, different network routers have different clock frequencies and thus transmit data packets at different speeds. If a data stream passes network routers of different speeds, a backlog of data packets can occur at the transition between a network router having a higher clock rate and a network router having a lower clock rate. This backlog can then influence other network traffic (also referred to as “head of line blocking”). As the resource management component controls or monitors the configuration of the network routers or is informed as soon as these are changed, the resource management component is aware of the state (meaning the clock rate, for example) of the network routers. In addition, the resource management component can be informed about the resource accesses of the transmitter. This enables the resource management component to detect, when the described case occurs. Therefore, this resource management component determines a new configuration for one or more components. A possible new configuration, which limits or prevents this backlog and the interferences caused by this, is the slowing down of data streams, for example by means of rate limiters, or the rerouting of data packets via alternative communication paths, as they exist in a Network on Chip, for example. For this purpose, the resource management component can, for example, assign new values for rate limiters or the network path to be selected to the transmitter of the network interface.

The described method can also be used to enable exclusive access to a resource or a path in the communication means, for a DMA transmission, for example. An exclusive access can help with improving the scheduling at the resource and preventing and reducing the data state (cf. head of line blocking). As the resource management component controls or monitors the configuration of the transmitters and is informed as soon as these are changed, the resource management component is aware of the state of the transmitters, such as, for example, the requested resources, the required data throughputs or data volume to be transmitted. Therefore, the resource management component can grant one or more transmitters exclusive access to one or more components/resources. For this purpose, the resource management component configures the transmitters or their network interface by, for example, reducing their allowed rates or blocks them entirely (for example by setting the rate to “zero”, an access denial or delay), so that only one transmitter is granted access. By doing so, the resource management component is able to change which transmitter is granted exclusive access in time intervals determined for the design time and for the runtime based, for example, on fixed time slots, a round robin method or fixed amounts of data.

A further specific application for the described method is the treatment of a changed, for example increased, temperature of the surroundings. In this regard, the resource management component detects, for example by reading a sensor or by a report from the sensor to the resource management component, that the temperature of the surroundings is too high. As a too high temperature of the surroundings can increase the probability of failure and the power consumption, the resource management component determines a new configuration for one or more components. A possible new configuration is, for example, a decreased clock frequency of one or more components or one or more components being switched off. In order to still ensure all real-time requirements and/or important functions, it may additionally be necessary to reroute network traffic in order to compensate for the reduced possible throughput of the network router now operating at a slower clock rate or to migrate functions to other components (to other processors for example). This, in turn, can mean further configuration steps, because the requested/necessary resources and communication paths change. Thus, it may, for example, be necessary, that after the rerouting of the data traffic to a new communication path, the rerouted data stream temporarily be given exclusive access to the communication path.

Further, the described method can also be used for treating a faulty component, such as, for example, a processor or a resource. In this regard, the resource management component detects, for example by reading a sensor or by a report from the sensor to the resource management component, that a component failed. The resource management component can then determine a new configuration for one or more components. A possible new configuration can, for example, provide the rerouting of network traffic or the migration of functions to other components (to other processors for example). This, in turn, can mean further configuration steps, because the requested/necessary resources and communication paths change. Thus, it may, for example, be necessary, that after the rerouting of the data traffic to a new communication path, this rerouted data stream temporarily be given exclusive access to the communication path.

As a person skilled in the art recognizes, based on the above information, the described measures of the configuration of the one or more network components, such as, for example rerouting network traffic, migrating functions to other components or temporarily granting exclusive access to the communication path to the rerouted data stream, reconfiguring the transmitters or their network interface, etc. are not only possible in case of the embodiments of the inventions in which the method is triggered without a request for access, but is, for example, controlled by an event. Rather, the described measures are of course also possible if, as with reference to the embodiments shown in FIG. 2, a request for a shared resource is the trigger for the method.

The method according to this further embodiment is enabled by a device comprising the corresponding means, such as, for example, a multiprocessor computer system as the multiprocessor computer system 100 described above, which, in particular, can be configured as an integrated circuit comprising a NoC as a communication means. The means for carrying out the method can be hardware means, software means or a combination of hardware and software means.

The method according to the present invention can also be executed on a computer as a computer program. In this case, the corresponding computer program product is adapted to carrying out the steps of the method described above.

The method and the devices according to the present invention allow that, for example, a worst case behavior of the NoC, for example a maximum latency of transmission or a minimum data throughput, or a worst case behavior of the application executed on the multiprocessor computer system 100, for example a maximum response time, can be guaranteed, so that it is possible to execute security-critical applications with real-time requirements by means of the method and the device.

At the same time, one or more of the following guarantees can be given for the suggested methods and the suggested devices, in particular if the multiprocessor computer system 100 is configured as an integrated circuit with a NoC as communication means 107:
i) maximum power consumption of the system, meaning of the integrated circuit too or individual components of the integrated circuit; this is achieved by means of different measures, such as, for example, the distribution of a load to several components or slowing down or switching off non-security-relevant applications or components. In this regard, the goal is to be able to perform security-critical applications in that failures or errors due to premature exhaustion of energy reserves are avoided or that the energy consumption of the system is optimized.
ii) maximum power consumption, maximum power dissipation and maximum thermal load of the integrated circuit 100, or the individual components of the integrated circuit; this is achieved by means of different measures, such as, for example, the distribution of a load to several components or slowing down or switching off non-security-relevant applications or components. In this regard, the goal is to prevent a thermal overload during the execution of security-critical applications, so that failures or errors due to thermal overload or voltage variations are avoided.
iii) Maximum influence of the response behavior of an application by another application; this is required, for example, by corresponding security standards and further serves the purpose of preventing or blocking DOS attacks, for example.
iv) Maintenance of the response behavior of an application after a change of at least one other application on a different processor of the computer system; this is, for example, relevant for system updates, where prescribed security standards are to be met. A change of an application using shared resources, can influence other applications via the shared resources. A further example for this is a performance of a resource increased by an update, which in turn leads to an increased interference on the shared resource and thus to an increased blocking time (of other applications on this resource).
v) Maintenance of the response behavior of an application after a change of at least one other application on the same processor of the computer system, wherein the application uses shared resources of the computer system; this is, for example, relevant for system updates, where prescribed security standards are to be met. Due to an increased number of accesses to a shared resource or the communication means, changing an application using shared resources can lead to an increased blocking time on the same processor (for other applications).
vi) Maintenance of the response behavior of an application after the failure of individual units that are not used by the application, in order to thus ensure a greater reliability of the operation of the integrated circuit and its components.
vii) Maintenance of the response behavior of the application, for example in case of an error and/or after failures of individual components of the integrated circuit that are used by the application, in order to thus ensure a greater reliability of the operation of the integrated circuit and its components.
viii) Maintenance of the function of the application after failures of individual components of the integrated circuit that are used by the application, in order to thus ensure a greater reliability of the operation of the integrated circuit and its components.

Thus, the present invention allows for a guaranteed response behavior of the multiprocessor computer system while simultaneously complying with the above guarantees. According to the invention, a tradeoff analysis is made between different parameters and a secure switching between the states of the integrated circuit and its components. In addition, the present invention enables an extension of the models used by the resource management component, which were created for the design time of the integrated circuit. Configurations suggested during the method according to the invention can be examined for their validity. Corresponding valid configurations can be stored, for example, in the form of tables or state machines that are accessible for the resource management component.

In addition, the resource management component can have access to models that model a behavior of applications, a connection between a number of transmitted packages per interval (throughput) and temperature, frequency and temperature or the like.

The models available to the resource management component as well as the valid configurations can be determined for the design time of the multiprocessor computer system and, if necessary, can be adapted by means of updates or dynamically for the runtime (for example by means of “machine learning” through the resource management component).

In addition, the present invention allows for a proactive behavior on the basis of monitoring information and is thus not limited to meeting prescribed real-time requirements only (“self-awareness” of the system).

The present invention allows for a predictable, dynamic (“online”) adaption of voltage and frequencies, for example, as well as further parameters of the system configuration. In addition, the present invention allows for a predictable behavior for data traffic and its influence on the rest of the system and/or other data streams, which, for example, passes several so-called voltage islands (of different speeds). Voltage island are areas in the communication means (network) that comprise a specific voltage and/or frequency (and thus a specific transmission speed). These areas include one or more routers of the communication means, which, for example, is formed as an NoC. If a data stream passes several of such (speed) voltage islands, this can cause blockages and backlogs at the transition. Especially when switching from a fast to a slower voltage island, there is a backlog at the transition. The propagation of these blockages further causes interferences that directly or indirectly lead to dependencies between transmitters. This makes it difficult or even impossible to comply with the prescribed real-time requirements and corresponding guarantees.

This problem is solved by the resource management component. In particular, the resource management component can adjust the voltage islands or the corresponding communication paths in the communication means (for example by allocating the same frequency to all concerned routers), adapt the transmission rate of the individual transmitter (for example by means of rate liners) and thus adapt them with regard to the “slowest route” in the communication means (so that a backlog of data packages at the transitions is avoided), or reroute data streams so that the occurring interferences are minimized. In sum, these measures allow for the prescribed real-time requirements and corresponding guarantees to be complied with again.

The invention further bears the advantage that the desired control of one or more components of a multiprocessor computer system, in particular of an integrated circuit, or the multiprocessor computer system itself can be provided with a predictable performance in any case, in particular with a guaranteed latency and/or guaranteed minimum data throughput. This is achieved in that a process of negotiation with the at least one resource management component or of optimization by means of the at least one resource management component is triggered by a connection request in advance, meaning before a communication between two components of the multiprocessor computer system takes place. It is further possible that the at least one resource management component uses the current system state to carry out an optimization of the multiprocessor computer system. In both cases, the at least one resource management component can use information from the design time and the runtime (for example by means of monitoring or requests) to determine a necessary configuration that is required for the compliance with prescribed guarantees, such as, for example, real-time requirements.

The present invention is particularly suitable for use as a controller in a vehicle.

1-21. (canceled)

22. A method for dynamic resource allocation in a multiprocessor computer system comprising a plurality of components, wherein said plurality of components comprises one or more processors, a resource management component and a communication means for a communication between the processors and the one or more shared resources,
the method comprising:
receiving a request for access to one of the shared resources from a requesting unit at the resource management component, wherein after an allocation of the requested shared resource to the requesting unit, at least one prescribed real-time requirement is to be ensured by the multiprocessor computer system;
determining of one or more current operating parameters of the multiprocessor computer system by the resource management component;
determining of one or more future operating parameters to be expected after an allocation of the requested shared resource to the requesting unit, based on a model of the multiprocessor computer system created for the design time of the multiprocessor computer system and one or more determined current operating parameters by the resource management component;
if the prescribed real-time requirement based on the determining of the future operating parameters to be expected, is ensured:
allocating of the requested resource to the requesting unit by the resource management component.

23. The method according to claim 22, wherein, if the prescribed real-time requirement based on the determining of the future operating parameters to be expected is not ensured:
based on said one or more determined current operating parameters and said one or more future operating parameters to be expected, determining of a configuration of one or more components of the multiprocessor computer system in that the prescribed real-time requirement for the requested resource is ensured by the configuration; and
if a corresponding configuration could be determined, configuring of said one or more components of the multiprocessor computer system according to the determined configuration by the resource management component, and
allocating of the requested resource to the requesting unit by the resource management component.

24. The method according to claim 22, wherein the allocation of the requested resource to the requesting unit by establishing a communication connection between the requesting unit and the requested resource is carried out via the communication means.

25. The method according to claim 22, wherein the determining of said one or more current operating parameters comprises at least one from a determining of:
a behavior of the requesting unit comprising a state and/or a pattern of previous resource accesses of the requesting unit;
an electric voltage and/or a clock frequency, by means of which said one or more of the components of the multiprocessor computer system are operated;
a temperature of one or more components of the multiprocessor computer system;
a number of data packets that were transmitted within a specified time period via the communication means.

26. The method according to claim 22, wherein the determining of said one or more future operating parameters to be expected comprises at least one from a determining of the following to be expected after the requested shared resource was allocated to the requesting unit:
electric voltage and/or clock frequency, by means of which said one or more of the components of the multiprocessor computer system are operated;
temperature of one or more components of the multiprocessor computer system;
average number of data packets that are to be expected via the communication means within a specified time period.

27. The method according to claim 22, wherein the configuring of said one or more components of the multiprocessor computer system comprises at least one of:
adjusting a clock rate and/or a frequency, by means of which said one or more of the components of the multiprocessor computer system are operated;
adjusting a maximum amount of data to be transmitted and/or received per time interval for an application executed on one or more of the processors and or a component of the multiprocessor computer system;
rerouting data packets existing in and/or to be transmitted by the communication means;
activating or deactivating an application carried out on one or more processors and/or a component of the multiprocessor computer system;
adjusting a time behavior of an application carried out on one or more processors.

28. The method according to claim 22, wherein the request comprises at least one parameter and wherein the parameter comprises one or more from a kind, a circumference and/or a response behavior of the requested shared resource.

29. The method according to claim 22, wherein the requesting unit is one of the following:
an application executed on one or more processors;
a component of a multiprocessor computer system;
a component external to the multiprocessor computer system.

30. The method according to claim 22, wherein the allocating of said requested resource to the requesting unit comprises a confirmation of the request prior to the allocation.

31. The method according to claim 22, wherein for the case that no corresponding configuration could be determined during the determining, that ensures the prescribed real-time requirement, the method comprises:
transmitting a rejection message to the requesting unit for rejecting the request via the resource management component.

32. The method according to claim 22, wherein the shared resource is a hardware resource or a software resource, and wherein a hardware resource is one of the following:
a sensor;
an actuator;
a memory, in particular main memory or cache memory;
a memory controller;
a hardware accelerator;
said communication means;
a gateway; and
an input/output means.

33. The method according to claim 22, wherein the communication means is configured as a communication means for an internal communication between components of the multiprocessor computer system and/or components external to the multiprocessor computer system.

34. The method according to claim 33, wherein said communication means is configured as a network on chip.

35. The method according to one claim 22, wherein the multiprocessor computer system is an integrated circuit.

36. The method according to claim 22, wherein said one or more shared resources are configured as internal resources or as resources external to the multiprocessor computer system.

37. The method according to claim 22, wherein the communication means are configured as a heterogeneous communication means, wherein:
components of the communication means comprise one or more clock frequencies; and/or
different router architectures are at hand in the communication means; and/or
different protocols are used in the communication means; and/or
different bandwidths are used on connections between routers in the communication means.

38. A device comprising means for carrying out the method according to claim 22.

39. The device according to claim 38, wherein the device is configured as a multiprocessor control device for a vehicle.

40. A computer program that is adapted to carrying out the method according to claim 22.

41. A method for dynamic resource allocation in a multiprocessor computer system comprising a plurality of components, wherein said plurality of components comprises one or more processors, a resource management component and a communication means for a communication between the processors and the one or more shared resources, the method comprising:
determining a real-time requirement that is to be ensured by the multiprocessor computer system after a reconfiguration of the multiprocessor computer system based on the resource management component;
determining of one or more current operating parameters of the multiprocessor computer system by the resource management component;
determining one or more future operating parameters to be expected after said reconfiguration, based on a model of the multiprocessor computer system created for the design time of the multiprocessor computer system and one or more determined current operating parameters by the resource management component;
if the real-time requirement based on the determining of the future operating parameters to be expected, is ensured:
reconfiguring of the multiprocessor computer system based on the resource management component.

42. A device comprising means for carrying out the method according claim 41.

43. A computer program that is adapted to carrying out the method according to claim 41.
